(19) United States
(12) Patent Application Publication
(10) Pub. No.: US 2009/0317626 A1
(43) Pub. Date: Dec. 24, 2009

(54) USE OF AQUEOUS COMPOSITE PARTICLE DISPERSIONS AS BINDING AGENTS IN COATINGS FOR TIMBER

(75) Inventors: Franca Tiarks, Pudong Shimao Riviera Garden (CN); Harm Wiese, Laudenbach (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/307,595

(22) PCT Filed: Jul. 11, 2007
(86) PCT No.: PCT/EP07/57077

§ 371 Date: Jan. 6, 2009

(30) Foreign Application Priority Data
Jul. 17, 2006 (EP) 06117323.3

(51) Int. Cl. C08K 3/36; C08K 3/22; C08K 3/26; C08K 3/32; B05D 3/02; B32B 5/16

(52) U.S. Cl. 428/331; 524/493; 524/430; 524/425; 524/424; 524/415; 524/431; 524/413; 524/432; 427/393; 428/323

(57) ABSTRACT

Use of aqueous composite particle dispersions as binders in wood coatings.

The present invention relates to the use of an aqueous dispersion of particles composed of polymer and finely divided inorganic solid (aqueous composite particle dispersion) as a binder in wood-coating formulations, in the preparation of the aqueous composite particle dispersion ethylenically unsaturated monomers being dispersed in an aqueous medium and polymerized by means of at least one free radical polymerization initiator in the presence of at least one dispersed, finely divided inorganic solid having a median particle diameter of ≦100 nm and at least one dispersant by the free radical aqueous emulsion polymerization method, and the ethylenically unsaturated monomers used being a monomer mixture which consists of ethylenically unsaturated monomers A and >0 and ≦10% by weight of at least one ethylenically unsaturated monomer B having an epoxide group (epoxide monomer).

The use of aqueous composite particle dispersions as binders in wood-coating formulations is known to the person skilled in the art (cf. for example J. Leuninger et al., Farbe & Lack (110), 10, 2004, pages 30 to 38). In particular, composite particle dispersions are used in wood-coating formulations if a balanced ratio between the hardness of the coating, which ensures early blocking resistance of the coating, and elasticity of the coating, which ensures good stability of the coating in the case of temperature variations, is desired. Aqueous composite particle dispersions whose polymer has a glass transition temperature in the range from −40 to +25° C. are advantageously used here, the finely divided inorganic solids used being in particular silica particles having a median particle size of from 10 to 30 nm and the content of silica particles in the composite particles being from 20 to 50% by weight. In comparison with the known acrylate-based binders, however, the known wood-coating formulations based on aqueous composite particle dispersions are not completely satisfactory with regard to the water permeability.

It was therefore the object of the present invention to provide aqueous composite particle dispersions as binders in wood-coating formulations to ensure a lower water permeability of the wood coatings.

Surprisingly, the object was achieved by the initially defined use of special aqueous composite particle dispersions.

Composite particles which are composed of polymer and finely divided inorganic solids are generally known, in particular in the form of their aqueous dispersions (aqueous composite particle dispersions). These are fluid systems which comprise particles composed of polymer coils consisting of a plurality of interlaced polymer chains, the so-called polymer matrix, and finely divided inorganic solids present as the disperse phase in an aqueous dispersing medium. The median diameter of the composite particles is as a rule in the range of ≧10 nm and ≦1000 nm, often in the range of ≧50 nm and ≦400 nm and frequently in the range of ≧100 nm and ≦300 nm.

Composite particles and processes for their production in the form of aqueous composite particle dispersions and the use thereof are known to the person skilled in the art and are disclosed, for example, in the publications U.S. Pat. No. 3,544,500, U.S. Pat. No. 4,421,660, U.S. Pat. No. 4,608,401, U.S. Pat. No. 4,981,882, EP-A 104 498, EP-A 505 230, EP-A 572 128, GB-A 2 227 739, WO 0118081, WO 0129106, WO 03000760 and in Long et al., Tianjin Daxue Xuebao 1991, 4, pages 10 to 15, Bourgeat-Lami et al., Die Angewandte Makromolekulare Chemie 1996, 242, pages 105 to 122, Paulke et al., Synthesis Studies of Paramagnetic Polystyrene Latex Particles in Scientific and Clinical Applications of Magnetic Carriers, pages 69 to 76, Plenum Press, New York, 1997, Armes et al., Advanced Materials 1999, 11, No. 5, pages 408 to 410.

The preparation of the aqueous composite particle dispersions is advantageously effected by dispersing ethylenically unsaturated monomers in an aqueous medium and polymerizing them by means of at least one free radical polymerization initiator in the presence of at least one dispersed, finely divided inorganic solid and at least one dispersant by the free radical aqueous emulsion polymerization method.

According to the invention, it is possible to use all aqueous composite particle dispersions, for example including those obtainable according to the abovementioned prior art, which were prepared using a monomer mixture which comprises >0 and ≦10% by weight, preferably from 0.1 to 5% by weight and particularly preferably from 0.5 to 3% by weight of epoxide monomers. Such aqueous composite particle dispersions and processes for their preparation are disclosed in particular in the non-prior-published German patent application with the application number DE 102 00 500 918.2, which is hereby incorporated by reference in this patent application.

According to the invention, those aqueous composite particle dispersions which were prepared using the monomer mixture comprising epoxide monomers by the procedure disclosed in WO 03000760 can advantageously be used. This process disclosed in WO 03000760 is distinguished in that the monomer mixture is dispersed in an aqueous medium and polymerized by means of at least one free radical polymerization initiator in the presence of at least one dispersed, finely divided inorganic solid and at least one dispersant by the free radical aqueous emulsion polymerization method,
a) a stable aqueous dispersion of the at least one inorganic solid being used, wherein said dispersion, at an initial solids concentration of ≧1% by weight, based on the aqueous dispersion of the at least one inorganic solid, still comprises more than 90% by weight of the originally dispersed solid in dispersed form one hour after its preparation, and the dispersed solid particles thereof have a median diameter of ≦100 nm,
b) the dispersed solid particles of the at least one inorganic solid exhibiting an electrophoretic mobility differing from zero in an aqueous standard potassium chloride solution at a pH which corresponds to the pH of the aqueous dispersing medium before the beginning of the addition of the dispersant,
c) at least one anionic, cationic and nonionic dispersant being added to the aqueous solid particle dispersion before the beginning of the addition of the monomer mixture,
d) from 0.01 to 30% by weight of the total amount of monomer mixture then being added to the aqueous solid particle dispersion and being polymerized to a conversion of at least 90%
   and
e) thereafter the remaining amount of the monomer mixture being added continuously under polymerization conditions at the rate of consumption.

All those finely divided inorganic solids which form stable aqueous dispersions which, at an initial solids concentration of ≧1% by weight, based on the aqueous dispersion of the at least one inorganic solid, still comprise more than 90% by weight of the originally dispersed solid in dispersed form one hour after their preparation without stirring or shaking and the dispersed solid particles thereof have a median diameter of ≦100 nm and moreover exhibit an electrophoretic mobility differing from zero at a pH which corresponds to the pH of the aqueous reaction medium before the beginning of the addition of the dispersant are suitable for this process.

The quantitative determination of the initial solids concentration and of the solids concentration after one hour and the determination of the median particle diameter are effected by the analytical ultracentrifuge method (cf. in this context S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175). The values stated in the case of the particle diameter correspond to the so-called d₅₀-values.

The method for the determination of the electrophoretic mobility is known to the person skilled in the art (cf. for example B. R. J. Hunter, Introduction to modern Colloid Science, chapter 8.4, pages 241 to 248, Oxford University Press, Oxford, 1993 and K. Oka and K. Furusawa, in Electrical Phenomena at Interfaces, Surfactant Science Series, vol. 76, chapter 8, pages 151 to 232, Marcel Dekker, New York, 1998). The electrophoretic mobility of the solid particles dispersed in the aqueous reaction medium is determined by means of a commercial electrophoresis apparatus, such as, for example, the Zetasizer 3000 from Malvern Instruments Ltd., at 20° C. and atmospheric pressure (1 atm=1.013 bar). For this purpose, the aqueous solid particle dispersion is diluted with a pH-neutral 10 millimolar (mM) aqueous potassium chloride solution (standard potassium chloride solution) until the solid particle concentration is about 50 to 100 mg/l. The adjustment of the measured sample to the pH which the aqueous reaction medium has before the beginning of the addition of the dispersants is effected by means of the customary inorganic acids, such as, for example, dilute hydrochloric acid or nitric acid, or bases, such as, for example, dilute sodium hydroxide solution or potassium hydroxide solution. The migration of the dispersed solid particles in the electric filed is detected by means of so-called electrophoretic light scattering (cf. for example B. B. R. Ware and W. H. Flygare, Chem. Phys. Lett. 1971, 12, pages 81 to 85). The sign of the electrophoretic mobility is defined by the migration direction of the dispersed solid particles, i.e. if the dispersed solid particles migrate to the cathode, their electrophoretic mobility is positive, and if on the other hand they migrate to the anode, it is negative.

A suitable parameter for influencing or adjusting the electrophoretic mobility of the dispersed solid particles in a certain range is the pH of the aqueous reaction medium. By protonation or deprotonation of the dispersed solid particles, the electrophoretic mobility is changed in the positive direction in the acidic pH range (pH<7) and in the negative direction in the alkaline range (pH>7). The pH range suitable for the process disclosed in WO 03000760 is that within which a free radical aqueous emulsion polymerization can be carried out. This pH range is as a rule from pH 1 to 12, frequently from pH 1.5 to 11 and often from pH 2 to 10.

The pH of the aqueous reaction medium can be adjusted by means of commercial acids, such as, for example, dilute hydrochloric, nitric or sulfuric acid, or bases, such as, for example, dilute sodium hydroxide or potassium hydroxide solution. It is frequently advantageous if a portion or the total amount of the acid or base used for the pH adjustment is added to the aqueous reaction medium before the at least one finely divided inorganic solid.

It is advantageous to the process disclosed according to WO 03000760 that, based on 100 parts by weight of monomer mixture, advantageously from 1 to 1000 parts by weight of the finely divided inorganic solid are used and, under the abovementioned pH conditions, when the dispersed solid particles
have an electrophoretic mobility with a negative sign, from 0.01 to 10 parts by weight, preferably from 0.05 to 5 parts by weight and particularly preferably from 0.1 to 3 parts by weight of at least one cationic dispersant, from 0.01 to 100 parts by weight, preferably from 0.05 to 50 parts by weight and particularly preferably from 0.1 to 20 parts by weight of at least one nonionic dispersant and at least one anionic dispersant are used, the amount thereof being such that the equivalent ratio of anionic to cationic dispersant is greater than 1, or
have an electrophoretic mobility with a positive sign, from 0.01 to 10 parts by weight, preferably from 0.05 to 5 parts by weight and particularly preferably from 0.1 to 3 parts by weight of at least one anionic dispersant, from 0.01 to 100 parts by weight, preferably from 0.05 to 50 parts by weight and particularly preferably from 0.1 to 20 parts by weight of at least one nonionic dispersant and at least one cationic dispersant are used, the amount thereof being such that the equivalent ratio of cationic to anionic dispersant is greater than 1.

Equivalent ratio of anionic to cationic dispersant is understood as meaning the ratio of the number of moles of anionic dispersant used multiplied by the number of anionic groups present per mole of the anionic dispersant, divided by the number of moles of the cationic dispersant used, multiplied by the number of cationic groups present per mole of the cationic dispersant. The same applies to the equivalent ratio of cationic to anionic dispersant.

The total amount of the at least one anionic, cationic or nonionic dispersant used according to WO 03000760 can be initially taken in the aqueous solid dispersion. However, it is also possible initially to take only a portion of said dispersants in the aqueous solid dispersion and to add the remaining amounts continuously or batchwise during the free radical emulsion polymerization. What is essential for the process, however, is that the abovementioned equivalent ratio of anionic and cationic dispersant be maintained as a function of the electrophoretic sign of the finely divided solid before and during free radical emulsion polymerization. If, therefore, inorganic solid particles which have an electrophoretic mobility with a negative sign under the abovementioned pH conditions are used, the equivalent ratio of anionic to cationic dispersant must be greater than 1 during the entire emulsion polymerization. In a corresponding manner, the equivalent ratio of cationic to anionic dispersant must be greater than 1 during the entire emulsion polymerization in the case of inorganic solid particles having an electrophoretic mobility with a positive sign. It is advantageous if the equivalent ratios are ≧2, ≧3, ≧4, ≧5, ≧6, ≧7, or ≧10, the equivalent ratios in the range from 2 to 5 being particularly advantageous.

Metals, metal compounds, such as metal oxides and metal salts, but also semi-metal and non-metal compounds, are suitable for the process disclosed in WO 03000760 and generally finely divided inorganic solids which can be used for the preparation of aqueous composite particle dispersions. Finely divided metal powders which may be used are noble metal colloids, such as, for example, palladium, silver, ruthenium, platinum, gold and rhodium, and alloys comprising these. Finely divided metal oxides which may be mentioned by way of example are titanium dioxide (for example commercially available as Hombitec® brands from Sachtleben Chemie GmbH), zirconium(IV) oxide, tin(II) oxide, tin(IV) oxide (for example commercially available as Nyacol® SN brands from Akzo-Nobel), alumina (for example commercially available as Nyacol® AL brands from Akzo-Nobel), barium oxide, magnesium oxide, various iron oxides, such as iron(II) oxide (wuestite), iron(III) oxide (hematite) and iron(II/III) oxide (magnetite), chromium(III) oxide, antimony(III) oxide, bismuth(III) oxide, zinc oxide (for example commercially available as Sachtotec® brands from Sachtleben Chemie GmbH), nickel(II) oxide, nickel(III) oxide, cobalt(II) oxide, cobalt(III) oxide, copper(II) oxide, yttrium(III) oxide (for example commercially available as Nyacol® YTTRIA brands from Akzo-Nobel), cerium(IV) oxide (for example commercially available as Nyacol® CEO2 brands from Akzo-Nobel) in amorphous form and/or in their different crystal modifications and hydroxyoxides thereof, such as, for example, hydroxytitanium(IV) oxide, hydroxyzirconium(IV) oxide, hydroxyaluminum oxide (for example commercially available as Disperal® brands from Condea-Chemie GmbH) and hydroxyiron(III) oxide, in amorphous form and/or in their different crystal modifications. The following metal salts present in amorphous form and/or in their different crystal structures can in principle be used in the method according to the invention: sulfides, such as iron(II) sulfide, iron(III) sulfide, iron(II) disulfide(pyrite), tin(II) sulfide, tin(IV) sulfide, mercury(II) sulfide, cadmium(II) sulfide, zinc sulfide, copper(II) sulfide, silver sulfide, nickel(II) sulfide, cobalt(II) sulfide, cobalt(III) sulfide, manganese(II) sulfide, chromium(III) sulfide, titanium(II) sulfide, titanium(III) sulfide, titanium(IV) sulfide, zirconium(IV) sulfide, antimony(III) sulfide, bismuth(III) sulfide, hydroxides, such as tin(II) hydroxide, aluminum hydroxide, magnesium hydroxide, calcium hydroxide, barium hydroxide, zinc hydroxide, iron(II) hydroxide, iron(III) hydroxide, sulfates, such as calcium sulfate, strontium sulfate, barium sulfate, lead(IV) sulfate, carbonates, such as lithium carbonate, magnesium carbonate, calcium carbonate, zinc carbonate, zirconium(IV) carbonate, iron(II) carbonate, iron(III) carbonate, orthophosphates, such as lithium orthophosphate, calcium orthophosphate, zinc orthophosphate, magnesium orthophosphate, aluminum orthophosphate, tin(III) orthophosphate, iron(II) orthophosphate, iron(III) orthophosphate, metaphosphates, such as lithium metaphosphate, calcium metaphosphate, aluminum metaphosphate, pyrophosphates, such as magnesium pyrophosphate, calcium pyrophosphate, zinc pyrophosphate, iron(III) pyrophosphate, tin(II) pyrophosphate, ammonium phosphates, such as magnesium ammonium phosphate, zinc ammonium phosphate, hydroxylapatite [Ca₅{(PO₄)₃OH}], orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate, zirconium(IV) orthosilicate, metasilicates, such as lithium metasilicate, calcium/magnesium metasilicate, calcium metasilicate, magnesium metasilicate, zinc metasilicate, sheet silicates, such as sodium aluminum silicate and sodium magnesium silicate, in particular in spontaneously delaminating form, such as, for example, Optigel® SH (brand of Südchemie AG), Saponit® SKS-20 and Hektorit® SKS 21 (brands of Hoechst AG) and Laponite® RD and Laponite® GS (brands of Laporte Industries Ltd.), aluminates, such as lithium aluminate, calcium aluminate, zinc aluminate, borates, such as magnesium metaborate, magnesium orthoborate, oxalates, such as calcium oxalate, zirconium(IV) oxalate, magnesium oxalate, zinc oxalate, aluminum oxalate, tartrates, such as calcium tartrate, acetylacetonates, such as aluminum acetylacetonate, iron(III) acetylacetonate, salicylates, such as aluminum salicylate, citrates, such as calcium citrate, iron(II) citrate, zinc citrate, palmitates, such as aluminum palmitate, calcium palmitate, magnesium palmitate, stearates, such as aluminum stearate, calcium stearate, magnesium stearate, zinc stearate, laurates, such as calcium laurate, linoleates, such as calcium linoleate, oleates, such as calcium oleate, iron(II) oleate or zinc oleate.

Silica present in amorphous form and/or in different crystal structures may be mentioned as a substantial semimetal compound which can be used according to the invention. Silica suitable according to the invention is commercially available and can be obtained, for example, as Aerosil® (brand of Degussa AG), Levasil® (brand of Bayer AG), Ludox® (brand of DuPont), Nyacol® and Bindzil® (brands of Akzo-Nobel) and Snowtex® (brand of Nissan Chemical Industries, Ltd.). Nonmetal compounds suitable according to the invention are, for example, colloidal graphite or diamond.

Particularly suitable finely divided inorganic solids are those whose solubility in water at 20° C. and atmospheric pressure is ≦1 g/l, preferably ≦0.1 g/l and in particular ≦0.01 g/l. Compounds selected from the group consisting of silica, alumina, tin(IV) oxide, yttrium(III) oxide, cerium(IV) oxide, hydroxyaluminum oxide, calcium carbonate, magnesium carbonate, calcium orthophosphate, magnesium orthophosphate, calcium metaphosphate, magnesium metaphosphate, calcium pyrophosphate, magnesium pyrophosphate, orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate, zirconium(IV) orthosilicate, metasilicates, such as lithium metasilicate, calcium/magnesium metasilicate, calcium metasilicate, magnesium metasilicate, zinc metasilicate, sheet silicates, such as sodium aluminum silicate and sodium magnesium silicate, in particular in spontaneously delaminating form, such as, for example, Optigel® SH, Saponit® SKS-20 and Hektorit® SKS 21 and Laponite® RD and Laponite® GS, iron(II) oxide, iron(III) oxide, iron(II/III) oxide, titanium dioxide, hydroxylapatite, zinc oxide and zinc sulfide are particularly preferred.

The at least one finely divided inorganic solid is preferably selected from the group consisting of silica, alumina, hydroxyaluminum oxide, calcium carbonate, magnesium carbonate, calcium orthophosphate, magnesium orthophosphate, iron(II) oxide, iron(III) oxide, iron(II/III) oxide, tin(IV) oxide, cerium(IV) oxide, yttrium(III) oxide, titanium dioxide, hydroxylapatite, zinc oxide and zinc sulfide.

Silicon-containing compounds, such as pyrogenic and/or colloidal silica, silica sols and/or sheet silicates, are particularly preferred. These silicon-containing compounds preferably have an electrophoretic mobility with a negative sign.

The commercially available compounds of the Aerosil®, Levasil®, Ludox®, Nyacol® and Bindzil® brands (silica), Disperal® brands (hydroxyaluminum oxide), Nyacol® AL brands (alumina), Hombitec® brands (titanium dioxide), Nyacol® SN brands (tin(IV) oxide), Nyacol® YTTRIA brands (yttrium(III) oxide), Nyacol® CEO2 brands (cerium(IV) oxide) and Sachtotec® brands (zinc oxide) can also advantageously be used in the method according to the invention.

The finely divided inorganic solids which can be used for the production of the composite particles are such that the solid particles dispersed in the aqueous reaction medium have a median particle diameter of ≦100 nm. Those finely divided inorganic solids whose dispersed particles have a median particle diameter of >0 nm but ≦90 nm, ≦80 nm, ≦70 nm, ≦60 nm, ≦50 nm, ≦40 nm, ≦30 nm, ≦20 nm or ≦10 nm and all values in between are successfully used. Advantageously used finely divided inorganic solids are those which have a particle diameter of ≦50 nm. The particle diameter is determined by the analytical ultracentrifuge method.

The accessibility of finely divided solids is known in principle to the person skilled in the art and is effective, for example, by precipitation reactions or chemical reactions in the gas phase (cf. in this context E. Matijevic, Chem. Mater. 1993, 5, pages 412 to 426; Ullmann's Encyclopedia of Industrial Chemistry, vol. A 23, pages 583 to 660, Verlag Chemie, Weinheim, 1992; D. F. Evans, H. Wennerström in The Colloidal Domain, pages 363 to 405, Verlag Chemie, Weinheim, 1994 and R. J. Hunter in Foundations of Colloid Science, vol. I, pages 10 to 17, Clarendon Press, Oxford, 1991).

The preparation of the stable solids dispersion is frequently effected directly in the synthesis of the finely divided inorganic solids in an aqueous medium or alternatively by dispersing the finely divided inorganic solid in the aqueous medium. Depending on the route of preparation of the finely divided inorganic solids, this is possible either directly, for example in the case of precipitated or pyrogenic silica, alumina, etc., or with the aid of suitable auxiliary units, such as, for example, dispersers or ultrasonic sonotrodes.

Those finely divided inorganic solids whose aqueous solids dispersion, at an initial solids concentration of ≧1% by weight, based on the aqueous dispersion of the finely divided inorganic solid, still comprises more than 90% by weight of the originally dispersed solid in dispersed form one hour after its preparation or by stirring up or shaking up the sedimented solids, without further stirring or shaking, and the dispersed solid particles thereof have a diameter of ≦100 nm are advantageously suitable for the preparation of the aqueous composite particle dispersions. Initial solids concentrations of ≦60% by weight are usual. However, initial solids concentrations of ≦55% by weight, ≦50% by weight, ≦45% by weight, ≦40% by weight, ≦35% by weight, ≦30% by weight, ≦25% by weight, ≦20% by weight, ≦15% by weight, ≦10% by weight, and ≧2% by weight, ≧3% by weight, ≧4% by weight or ≧5% by weight and all values in between, based in each case on the aqueous dispersion of the finely divided inorganic solid, can also advantageously be used. In the preparation of aqueous composite particle dispersions, frequently from 1 to 1000 parts by weight, as a rule from 5 to 300 parts by weight and often from 10 to 200 parts by weight of the at least one finely divided inorganic solid, based on 100 parts by weight of a monomer mixture, are used. Advantageously from 10 to 50 parts by weight and particularly advantageously from 25 to 40 parts by weight of the at least one finely divided inorganic solid, based on 100 parts by weight of a monomer mixture, are used.

In the preparation of the aqueous composite particle dispersions, dispersants which keep both the finely divided inorganic solid particles and the monomer droplets and the composite particles formed in dispersion in the aqueous phase and thus ensure the stability of the aqueous composite particle dispersions produced are generally concomitantly used. Suitable dispersants are both the protective colloids usually used for carrying out free radical aqueous emulsion polymerizations and emulsifiers.

A detailed description of suitable protective colloids is to be found in Houben-Weyl, Methoden der organischen Chemie, volume XIV/1, Makromolekulare Stoffe, Georg-Thieme-Verlag, Stuttgart, 1961, pages 411 to 420.

Suitable neutral protective colloids are, for example, polyvinyl alcohols, polyalkylene glycols, and cellulose, starch and gelatin derivatives.

Suitable anionic protective colloids, i.e. protective colloids whose components having a dispersing effect has at least one negative electrical charge, are, for example, polyacrylic acids and polymethacrylic acids and alkali metal salts thereof, copolymers comprising acrylic acid, methacrylic acid, 2-acrylamido-2-methylpropanesulfonic acid, 4-styrenesulfonic acid and/or maleic anhydride, and alkali metal salts thereof, and alkali metal salts of sulfonic acids of high molecular weight compounds, such as, for example, polystyrene.

Suitable cationic protective colloids, i.e. protective colloids whose component having a dispersing effect has at least one positive electrical charge, are, for example, those derivatives of N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide and homo- and copolymers comprising amino group-carrying acrylates, methacrylates, acrylamides and/or methacrylamides which are protonated and/or alkylated on the nitrogen.

Of course, it is also possible to use mixtures of emulsifiers and/or protective colloids. Frequently, exclusively emulsifiers whose relative molecular weights, in contrast to the protective colloids, are usually below 1500 are used as dispersants. In the case of the use of mixtures of surface-active substances, the individual components must of course be compatible with one another, which, in case of doubt, can be checked by means of a few preliminary experiments. An overview of suitable emulsifiers is to be found in Houben-Weyl, Methoden der organischen Chemie, volume XIV/1, Makromolekulare Stoffe, Georg-Thieme-Verlag, Stuttgart, 1961, pages 192 to 208.

Customary nonionic emulsifiers are, for example, ethoxylated mono-, di- and trialkylphenols (degree of ethoxylation: 3 to 50, alkyl radical: C₄ to C₁₂) and ethoxylated fatty alcohols (degree of ethoxylation: 3 to 80; alkyl radical: C₈ to C₃₆). Examples of these are the Lutensol® A brands (C₁₂C₁₄-fatty alcohol ethoxylates, degree of ethoxylation: 3 to 8), Lutensol® AO brands (C₁₃C₁₅-oxo alcohol ethoxylates, degree of ethoxylation: 3 to 30), Lutensol® AT brands (C₁₆C₁₈-fatty alcohol ethoxylates, degree of ethoxylation: 11 to 80), Lutensol® ON brands (C₁₀-oxo alcohol ethoxylates, degree of ethoxylation: 3 to 11) and the Lutensol® TO brands (C₁₃-oxo alcohol ethoxylates, degree of ethoxylation: 3 to 20) from BASF AG.

Customary anionic emulsifiers are, for example, alkali metal and ammonium salts of alkyl sulfates (alkyl radical: C₈ to C₁₂), of sulfuric monoesters of ethoxylated alkanols (degree of ethoxylation: 4 to 30, alkyl radical: C₁₂ to C₁₈) and of ethoxylated alkylphenols (degree of ethoxylation: 3 to 50, alkyl radical: C₄ to C₁₂), of alkanesulfonic acids (alkyl radical: C₁₂ to C₁₈) and of alkylarylsulfonic acids (alkyl radical: C₉ to C₁₈).

Furthermore, compounds of the general formula I

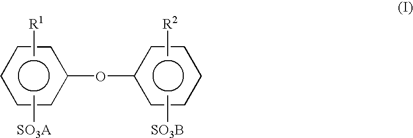

where R¹ and R² are H atoms or C₄- to C₂₄-alkyl and are not simultaneously H atoms, and A and B may be alkali metal ions and/or ammonium ions, have proven suitable as further anionic emulsifiers. In the general formula I, R¹ and R² are preferably linear or branched alkyl radicals having 6 to 18 carbon atoms, in particular having 6, 12 and 16 carbon atoms, or —H, R¹ and R² not both simultaneously being H atoms. A and B are preferably sodium, potassium or ammonium, sodium being particularly preferred. Compounds I in which A and B are sodium, R¹ is a branched alkyl radical having 12 carbon atoms and R² is an H atom or R¹ are particularly advantageous. Industrial mixtures which have a proportion of from 50 to 90% by weight of the monoalkylated product, such as, for example, Dowfax® 2A1 (brand of Dow Chemical Company), are frequently used. The compounds I are generally known, for example from U.S. Pat. No. 4,269,749, and are commercially available.

Suitable cationic emulsifiers are as a rule primary, secondary, tertiary or quaternary ammonium salts, alkanolammonium salts, pyridinium salts, imidazolinium salts, oxazolinium salts, morpholinium salts, thiazolinium salts having a C₆- to C₁₈-alkyl, C₆- to C₁₈-aralkyl or heterocyclic radical and salts of amine oxides, quinolinium salts, isoquinolinium salts, tropylium salts, sulfonium salts and phosphonium salts. Dodecylammonium acetate or the corresponding hydrochloride, the chlorides or acetates of the various 2-(N,N,N-trimethylammonium)ethylparaffin acid esters, N-cetylpyridinium chloride, N-laurylpyridinium sulfate and N-cetyl-N,N,N-trimethylammonium bromide, N-dodecyl-N,N,N-trimethylammonium bromide, N-octyl-N,N,N-trimethlyammonium bromide, N,N-distearyl-N,N-dimethylammonium chloride and the Gemini surfactant N,N′-(lauryldimethyl)ethylenediamine dibromide may be mentioned by way of example. Numerous further examples are to be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

From 0.1 to 10% by weight, often from 0.5 to 7.0% by weight and frequently from 1.0 to 5.0% by weight of dispersant, based in each case on the total amount of aqueous composite particle dispersion, are frequently used for the preparation of the aqueous composite particle dispersions. Emulsifiers, in particular nonionic and/or anionic emulsifiers, are preferably used. In the process disclosed in WO 03000760, anionic, cationic and nonionic emulsifiers are used as dispersants.

It is essential to the invention that a monomer mixture which consists of ethylenically unsaturated monomers A and >0 and ≦10% by weight of at least one ethylenically unsaturated monomer B having an epoxide group (epoxide monomer) is used for the preparation of the aqueous composite particle dispersion which can be used according to the invention.

Suitable monomers A are, inter alia, in particular ethylenically unsaturated monomers which can be subjected to free radical polymerization in a simple manner, such as, for example, ethylene, vinylaromatic monomers, such as styrene, α-methylstyrene, o-chlorostyrene or vinyltoluenes, esters of vinyl alcohol and monocarboxylic acids having 1 to 18 carbon atoms, such as vinyl acetate, vinyl propionate, vinyl n-butyrate, vinyl laurate and vinyl stearate, esters of α,β-monoethylenically unsaturated mono- and dicarboxylic acids preferably having 3 to 6 carbon atoms, such as, in particular, acrylic acid, methacrylic acid, maleic acid, fumaric acid and itaconic acid, alkanols having in general 1 to 12, preferably 1 to 8 and in particular 1 to 4 carbon atoms, such as, in particular methyl, ethyl, n-butyl, isobutyl and 2-ethylhexyl acrylate and methacrylate, dimethyl maleate or di-n-butyl maleate, nitriles of α,β-monoethylenically unsaturated carboxylic acids, such as acrylonitrile, and C₄₋₈-conjugated dienes, such as 1,3-butadiene and isoprene. Said monomers form as a rule the main monomers, which together usually account for a proportion of ≧50% by weight, ≧80% by weight, or ≧90% by weight, based on the total amount of the monomers A to be polymerized by the process according to the invention. As a rule, these monomers have only a moderate to low solubility in water under standard conditions (20° C., atmospheric pressure).

Further monomers A which usually increase the internal strength of the films of the polymer matrix usually have at least one hydroxyl, N-methylol or carbonyl group or at least two non-conjugated ethylenically unsaturated double bonds. Examples of these are monomers having two vinyl radicals, monomers having two vinylidene radicals and monomers having two alkenyl radicals. The diesters of dihydric alcohols with α,β-monoethylenically unsaturated monocarboxylic acids are particularly advantageous, among which acrylic and methacrylic acid are preferred. Examples of such monomers having two non-conjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, and 1,4-butylene glycol dimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of particular importance in this context are the C₁-C₈-hydroxyalkyl methacrylates and acrylates, such as n-hydroxyethyl, n-hydroxypropyl or n-hydroxybutyl acrylate and methacrylate, and compounds such as diacetoneacrylamide and acetylacetoxyethyl acrylate or methacrylate. According to the invention, the abovementioned monomers are used for the polymerization in amounts of up to 5% by weight, in particular from 0.1 to 3% by weight and preferably from 0.5 to 2% by weight, based on the total amount of the monomers A to be polymerized.

Ethylenically unsaturated monomers comprising siloxane groups, such as the vinyltrialkoxysilanes, for example vinyltrimethoxysilane, alkylvinyldialkoxysilanes, acryloyloxyalkyltrialkoxysilanes, or methacryloyloxyalkyltrialkoxysilanes, such as, for example, acryloyloxyethyltrimethoxysilane, methacryloyloxyethyltrimethoxysilane, acryloyloxypropyltrimethoxysilane or methacryloyloxypropyltrimethoxysilane, can also be used as monomers A. These monomers are used in total amounts of up to 5% by weight, frequently from 0.01 to 3% by weight and more often from 0.05 to 1% by weight, based in each case on the total amount of the monomers A. According to the invention, monomers A comprising abovementioned siloxane groups are advantageously used in total amounts of from 0.01 to 5% by weight, in particular from 0.01 to 3% by weight and preferably from 0.05 to 1% by weight, based in each case on the total amount of the monomers A to be polymerized. It is important that the ethylenically unsaturated monomers comprising abovementioned siloxane groups can be metered simultaneously with or after the other monomers A.

Those ethylenically unsaturated monomers AS which comprise either at least one acid group and/or the corresponding anion thereof or those ethylenically unsaturated monomers AN which comprise at least one amino, amido, ureido or N-heterocyclic group and/or the ammonium derivatives thereof protonated or alkylated on the nitrogen can additionally be used as monomers A. The amount of monomers AS or monomers AN is up to 10% by weight, often from 0.1 to 7% by weight and frequently from 0.2 to 5% by weight, based on the total amount of the monomers A to be polymerized.

Ethylenically unsaturated monomers having at least one acid group are used as monomers AS. The acid group may be, for example, a carboxyl, sulfo, sulfuric acid, phosphoric acid and/or phosphonic acid group. Examples of such monomers AS are acrylic acid, methacrylic acid, maleic acid, fumaric acid, itaconic acid, crotonic acid, 4-styrenesulfonic acid, 2-methacryloyloxyethylsulfonic acid, vinylsulfonic acid and vinylphosphonic acid, and phosphoric acid monoesters of n-hydroxyalkyl acrylates and n-hydroxyalkyl methacrylates, such as, for example, phosphoric acid monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate. According to the invention, however, it is also possible to use the ammonium and alkali metal salts of the abovementioned ethylenically unsaturated monomers having at least one acid group. Sodium and potassium are particularly preferred as the alkali metal. Examples of these are the ammonium, sodium and potassium salts of acrylic acid, methacrylic acid, maleic acid, fumaric acid, itaconic acid, crotonic acid, 4-styrenesulfonic acid, 2-methacryloyloxyethylsulfonic acid, vinylsulfonic acid and vinylphosphonic acid and the mono- and diammonium, mono- and disodium and mono- and dipotassium salts of the phosphoric acid monoesters of hydroxyethyl acrylate, n-hydroxypropyl acrylate, n-hydroxybutyl acrylate and hydroxyethyl methacrylate, n-hydroxypropyl methacrylate or n-hydroxybutyl methacrylate.

Acrylic acid, methacrylic acid, maleic acid, fumaric acid, itaconic acid, crotonic acid, 4-styrenesulfonic acid, 2-methacryloyloxyethylsulfonic acid, vinylsulfonic acid and vinylphosphonic acid are preferably used as monomers AS.

Ethylenically unsaturated monomers which comprise at least one amino, amido, ureido or N-heterocyclic group and/or the ammonium derivatives thereof protonated or alkylated on the nitrogen are used as monomers AN.

Examples of monomers AN which comprise at least one amino group are 2-aminoethyl acrylate, 2-aminoethyl methacrylate, 3-aminopropyl acrylate, 3-aminopropyl methacrylate, 4-amino-n-butyl acrylate, 4-amino-n-butyl methacrylate, 2-(N-methylamino)ethyl acrylate, 2-(N-methylamino)ethyl methacrylate, 2-(N-ethylamino)ethyl acrylate, 2-(N-ethylamino)ethyl methacrylate, 2-(N-n-propylamino)ethyl acrylate, 2-(N-n-propylamino)ethyl methacrylate, 2-(N-isopropylamino)ethyl acrylate, 2-(N-isopropylamino)ethyl methacrylate, 2-(N-tert-butylamino)ethyl acrylate, 2-(N-tert-butylamino)ethyl methacrylate (for example commercially available as Norsocryl® TBAEMA from Elf Atochem), 2-(N,N-dimethylamino)ethyl acrylate (for example commercially available as Norsocryl® ADAME from Elf Atochem), 2-(N,N-dimethylamino)ethyl methacrylate (for example, commercially available as Norsocryl® MADAME from Elf Atochem), 2-(N,N-diethylamino)ethyl acrylate, 2-(N,N-diethylamino)ethyl methacrylate, 2-(N,N-di-n-propylamino)ethyl acrylate, 2-(N,N-di-n-propylamino)ethyl methacrylate, 2-(N,N-diisopropylamino)ethyl acrylate, 2-(N,N-diisopropylamino)ethyl methacrylate, 3-(N-methylamino)propyl acrylate, 3-(N-methylamino)propyl methacrylate, 3-(N-ethylamino)propyl acrylate, 3-(N-ethylamino)propyl methacrylate, 3-(N-n-propylamino)propyl acrylate, 3-(N-n-propylamino)propyl methacrylate, 3-(N-isopropylamino)propyl acrylate, 3-(N-isopropylamino)propyl methacrylate, 3-(N-tert-butylamino)propyl acrylate, 3-(N-tert-butylamino)propyl methacrylate, 3-(N,N-dimethylamino)propyl acrylate, 3-(N,N-dimethylamino)propyl methacrylate, 3-(N,N-diethylamino)propyl acrylate, 3-(N,N-diethylamino)propyl methacrylate, 3-(N,N-di-n-propylamino)propyl acrylate, 3-(N,N-di-n-propylamino)propyl methacrylate, 3-(N,N-diisopropylamino)propyl acrylate and 3-(N,N-diisopropylamino)propyl methacrylate.

Examples of monomers AN which comprise at least one amido group are acrylamide, methacrylamide, N-methylacrylamide, N-methylmethacrylamide, N-ethylacrylamide, N-ethylmethacrylamide, N-n-propylacrylamide, N-n-propylmethacrylamide, N-isopropylacrylamide, N-isopropylmethacrylamide, N-tert-butylacrylamide, N-tert-butylmethacrylamide, N,N-dimethylacrylamide, N,N-dimethylmethacrylamide, N,N-diethylacrylamide, N,N-diethylmethacrylamide, N,N-di-n-propylacrylamide, N,N-di-n-propylmethacrylamide, N,N-diisopropylacrylamide, N,N-diisopropylmethacrylamide, N,N-di-n-butylacrylamide, N,N-di-n-butylmethacrylamide, N-(3-N′,N′-dimethylaminopropyl)methacrylamide, diacetoneacrylamide, N,N′-methylenebisacrylamide, N-(diphenylmethyl)acrylamide and N-cyclohexylacrylamide, but also N-vinylpyrrolidone and N-vinylcaprolactam.

Examples of monomers AN which comprise at least one ureido group are N,N′-divinylethyleneurea and 2-(1-imidazolin-2-onyl)ethyl methacrylate (for example commercially available as Norsocryl® 100 from Elf Atochem).

Examples of monomers AN which comprise at least one N-heterocyclic group are 2-vinylpyridine, 4-vinylpyridine, 1-vinylimidazole, 2-vinylimidazole and N-vinylcarbazole.

The following compounds are preferably used as monomers AN: 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolin-2-onyl)ethyl methacrylate. Depending on the pH of the aqueous reaction medium, a part or the total amount of the abovementioned nitrogen-containing monomers AN may be present in the quaternary ammonium form protonated on the nitrogen.

2-(N,N,N-Trimethylammonium)ethyl acrylate chloride, for example commercially available as Norsocryl® ADAMQUAT MC 80 from Elf Atochem), 2-(N,N,N-trimethylammonium)ethyl methacrylate chloride (for example commercially available as Norsocryl® MADQUAT MC 75 from Elf Atochem), 2-(N-methyl-N,N-diethylammonium)ethyl acrylate chloride, 2-(N-methyl-N,N-diethylammonium)ethyl methacrylate chloride, 2-(N-methyl-N,N-dipropylammonium)ethyl acrylate chloride, 2-(N-methyl-N,N-dipropylammonium)ethyl methacrylate, 2-(N-benzyl-N,N-dimethylammonium)ethyl acrylate chloride (for example commercially available as Norsocryl® ADAMQUAT BZ 80 from Elf Atochem), 2-(N-benzyl-N,N-dimethylammonium)ethyl methacrylate chloride (for example commercially available as Norsocryl® MADQUAT BZ 75 from Elf Atochem), 2-(N-benzyl-N,N-diethylammonium)ethyl acrylate chloride, 2-(N-benzyl-N,N-diethylammonium)ethyl methacrylate chloride, 2-(N-benzyl-N,N-dipropylammonium)ethyl acrylate chloride, 2-(N-benzyl-N,N-dipropylammonium)ethyl methacrylate chloride, 3-(N,N,N-trimethylammonium)propyl acrylate chloride, 3-(N,N,N-trimethylammonium)propyl methacrylate chloride, 3-(N-methyl-N,N-diethylammonium)propyl acrylate chloride, 3-(N-methyl-N,N-diethylammonium)propyl methacrylate chloride, 3-(N-methyl-N,N-dipropylammonium)propyl acrylate chloride, 3-(N-methyl-N,N-dipropylammonium)propyl methacrylate chloride, 3-(N-benzyl-N,N-dimethylammonium)propyl acrylate chloride, 3-(N-benzyl-N,N-dimethylammonium)propyl methacrylate chloride, 3-(N-benzyl-N,N-diethylammonium)propyl acrylate chloride, 3-(N-benzyl-N,N-diethylammonium)propyl methacrylate chloride, 3-(N-benzyl-N,N-dipropylammonium)propyl acrylate chloride and 3-(N-benzyl-N,N-dipropylammonium)propyl methacrylate chloride may be mentioned by way of example as monomers AN which have a quaternary alkylammonium structure on the nitrogen. Of course, the corresponding bromides and sulfates may also be used instead of said chlorides.

2-(N,N,N-Trimethylammonium)ethyl acrylate chloride, 2-(N,N,N-trimethylammonium)ethyl methacrylate chloride, 2-(N-benzyl-N,N-dimethylammonium)ethyl acrylate chloride and 2-(N-benzyl-N,N-dimethylammonium)ethyl methacrylate chloride are preferably used.

It is of course also possible to use mixtures of the abovementioned ethylenically unsaturated monomers AS or AN.

What is important is that, in the case of WO 03000760, a portion or the total amount of the at least one anionic dispersant can be replaced by the equivalent amount of at least one monomer AS when dispersed solid particles having an electrophoretic mobility with a negative sign are present, and a portion of the total amount of the at least one cationic dispersant can be replaced by the equivalent amount of at least one monomer AN when dispersed solid particles having an electrophoretic mobility with a positive sign are present.

Particularly advantageously, the composition of the monomers A is chosen so that, after polymerization of them alone, a polymer whose glass transition temperature is ≦100° C., preferably ≦60° C., in particular ≦40° C. and frequently ≧−30° C. and often ≧−20° C. or ≧−10° C. would result.

Usually, the determination of the glass transition temperature is effected according to DIN 53 765 (differential scanning calorimetry, 20 K/min, midpoint measurement).

According to Fox (T. G. Fox, Bull. Am. Phys. Soc. 1956 [Ser. II] 1, page 123 and according to Ullmann's Encyclopädie der technischen Chemie, vol. 19, page 18, 4th edition, Verlag Chemie, Weinheim, 1980) the following is a good approximation for the glass transition temperature T_{g} of at most weakly crosslinked copolymers:

1/T_{g}=x¹/T_{g}¹+x²/T_{g}²+ . . . xⁿ/T_{g}ⁿ,

where x¹, x², . . . xⁿ are the mass fractions of the monomers 1, 2, . . . n and T_{g}¹, T_{g}², . . . T_{g}ⁿ are the glass transition temperatures of the polymers composed in each case only of one of the monomers 1, 2, . . . n, in degrees Kelvin. The T_{g} values for the homopolymers of most monomers are known and are stated, for example, in Ullmann's Encyclopedia of Industrial Chemistry, 5th edition, vol. A21, page 169, Verlag Chemie, Weinheim, 1992; further sources of glass transition temperatures of homopolymers are, for example, B. J. Brandrup, E. H. Immergut, Polymer Handbook, 1^{st} Ed., J. Wiley, New York, 1966; 2^{nd} Ed. J. Wiley, New York, 1975 and 3^{rd} Ed. J. Wiley, New York, 1989.

All ethylenically unsaturated compounds which have at least one epoxide group can be used as monomer B (epoxide monomer). In particular, however, the at least one epoxide monomer is selected from the group consisting of 1,2-epoxy-3-butene, 1,2-epoxy-3-methyl-3-butene, glycidyl acrylate(2,3-epoxypropyl acrylate), glycidyl methacrylate(2,3-epoxypropyl methacrylate), 2,3-epoxybutyl acrylate, 2,3-epoxybutyl methacrylate, 3,4-epoxybutyl acrylate and 3,4-epoxybutyl methacrylate and the corresponding alkoxylated, in particular ethoxylated and/or propoxylated glycidyl acrylates and glycidyl methacrylates, as disclosed, for example, in U.S. Pat. No. 5,763,629. According to the invention, it is of course also possible to use mixtures of epoxide monomers. Glycidyl acrylate and/or glycidyl methacrylate are preferably used as epoxide monomers.

Based on the total amount of monomers, the amount of epoxide monomer is >0 and ≦10% by weight. Frequently, the total amount of epoxide monomer is ≧0.01% by weight, ≧0.1% by weight or ≧0.5% by weight, often ≧0.8% by weight, ≧1% by weight or ≧1.5% by weight, or ≦8% by weight, ≦7% by weight or ≦6% by weight and often ≦5% by weight, ≦4% by weight or ≦3% by weight, based in each case on the total amount of monomers. The amount of epoxide monomers is preferably ≧0.1 and ≦5% by weight and particularly preferably ≧0.5 and ≦3% by weight, based in each case on the total amount of monomers.

Accordingly, the monomer mixture to be polymerized preferably consists of ≧95 and ≦99.9% by weight and particularly preferably ≧97 and ≦99.5% by weight of monomers A and ≧0.1 and ≦5% by weight and particularly preferably ≧0.5 and ≦3% by weight of epoxide monomers.

What is important is that, according to the invention, the epoxide monomers are used as a monomer mixture with the monomers A. However, it is also possible to meter the epoxide monomers into the aqueous polymerization medium separately and simultaneously with the monomers A. The epoxide monomers can be metered into the polymerization medium batchwise in one or more portions or continuously at constant or varying flow rates. As a rule, the epoxide monomers are, however, fed to the polymerization medium together with the monomers A as a monomer mixture.

Advantageously, the monomer mixture to be polymerized is chosen so that the polymer obtained therefrom has a glass transition temperature of ≦100° C., preferably ≦60° C. or ≦40° C., in particular ≦30° C. or ≦20° C. and frequently ≧−30° C. or ≧−15° C. a ≧−10° C. or ≧−5° C. and hence the aqueous composite particle dispersions—if appropriate in the presence of customary film formation assistants—can be converted in a simple manner into the polymer films comprising the finely divided inorganic solids (composite films).

For the preparation of the aqueous composite particle dispersion which can be used according to the invention by free radical polymerization, suitable free radical polymerization initiators are all those which are capable of initiating a free radical aqueous emulsion polymerization. These can in principle be both peroxides and azo compounds. Of course, redox initiator systems are also suitable. Peroxides used can in principle be inorganic peroxides, such as hydrogen peroxide or peroxodisulfates, such as the mono- or di-alkali metal or ammonium salts of peroxodisulfuric acid, such as, for example, the mono- and disodium, mono- and dipotassium or ammonium salts thereof, or organic peroxides, such as alkyl hydroperoxides, for example tert-butyl, p-menthyl, or cumyl hydroperoxide, and dialkyl or diaryl peroxides, such as di-tert-butyl or dicumyl peroxide. Essentially 2,2′-azobis(isobutyronitrile), 2,2′-azobis(2,4-dimethylvaleronitrile) and 2,2′-azobis(amidinopropyl)dihydrochloride (AIBA, corresponds to V-50 from Wako Chemicals) are used as the azo compound. Essentially the abovementioned peroxides are suitable as oxidizing agents for redox initiator systems. Sulfur compounds having a low oxidation state, such as alkali metal sulfites, for example potassium and/or sodium sulfite, alkali metal hydrogen sulfites, for example potassium and/or sodium hydrogen sulfite, alkali metal metabisulfites, for example potassium and/or sodium metabisulfite, formaldehyde sulfoxylates, for example potassium and/or sodium formaldehyde sulfoxylate, alkali metal salts, especially potassium and/or sodium salts or aliphatic sulfinic acids, and alkali metal hydrogen sulfides, such as, for example, potassium and/or sodium hydrogen sulfide, salts of polyvalent metals, such as iron(II) sulfate, iron(II) ammonium sulfate, iron(II) phosphate, enediols, such as dihydroxymaleic acid, benzoin and/or ascorbic acid, and reducing saccharides such as sorbose, glucose, fructose and/or dihydroxyacetone, may be used as corresponding reducing agents. As a rule, the amount of the free radical polymerization initiator used is from 0.1 to 5% by weight, based on the total amount of the monomer mixture.

The entire range from 0 to 170° C. is suitable as a reaction temperature for the free radical aqueous polymerization reaction in the presence of the finely divided inorganic solid. As a rule, temperatures of from 50 to 120° C., frequently from 60 to 110° C. and often from ≧70 to 100° C. are used. The free radical aqueous emulsion polymerization can be carried out at a pressure less than, equal to or greater than 1 bar (absolute), it being possible for the polymerization temperature to exceed 100° C. and to be up to 170° C. Preferably, readily volatile monomers, such as ethylene, butadiene or vinyl chloride are polymerized under superatmospheric pressure. The pressure may be 1.2, 1.5, 2, 5, 10 or 15 bar or may assume even higher values. If emulsion polymerizations are carried out under reduced pressure, pressures of 950 mbar, frequently of 900 mbar and often of 850 mbar (absolute) are established. Advantageously, the free radical aqueous emulsion polymerization is carried out at 1 atm (absolute) under an inert gas atmosphere, such as, for example, under nitrogen or argon.

The aqueous reaction medium can in principle also comprise minor amounts of water-soluble organic solvents, such as, for example, methanol, ethanol, isopropanol, butanols, pentanols, but also acetone, etc. However, the polymerization reaction is preferably effected in the absence of such solvents.

In addition to the abovementioned components, free radical chain transfer compounds can optionally also be used in the processes for the preparation of the aqueous composite particle dispersion in order to reduce or to control the molecular weight of the polymers obtainable by the polymerization. Substantially aliphatic and/or araliphatic halogen compounds, such as, for example, n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride and benzyl bromide, organic thio compounds, such as primary, secondary or tertiary aliphatic thiols, such as, for example, ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as, for example, 2-hydroxyethanethiol, aromatic thiols, such as benzenethiol, or ortho-, meta-, or para-methylbenzenethiol, and all further sulfur compounds described in Polymer Handbook 3^{rd} edition, 1989, J. Brandrup and E. H. Immergut, John Wiley & Sons, section II, pages 133 to 141, but also aliphatic and/or aromatic aldehydes, such as acetaldehyde, propionaldehyde and/or benzaldehyde, unsaturated fatty acids, such as oleic acid, dienes having non-conjugated double bonds, such as divinylmethane or vinylcyclohexane, or hydrocarbons having readily abstractable hydrogen atoms, such as, for example, toluene, are used. However, it is also possible to use mixtures of abovementioned free radical chain transfer compounds which do not interfere. The optionally used total amount of the free radical chain transfer compounds is as a rule ≦5% by weight, often ≦3% by weight and frequently ≦1% by weight, based on the total amount of the monomers to be polymerized.

The aqueous composite particle dispersions obtainable by the process according to the invention usually have a total solids content of from 1 to 70% by weight, frequently from 5 to 65% by weight and often from 10 to 60% by weight.

The composite particles obtainable by the various processes, in particular according to the process disclosed in WO 03000760, have as a rule median particle diameter in the range of ≧10 nm and ≦1000 nm, frequently in the range of ≧50 nm and ≦400 nm and often in the range of ≧100 nm and ≦300 nm. The determination of the median composite particle diameter is also effected by the analytical centrifuge method (cf. in this context S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175). The stated values correspond to the so-called d₅₀ values. Those composite particle dispersions whose composite particles have a median particle diameter of ≧50 nm and ≦300 nm, preferably ≦200 nm and in particular ≦150 nm are advantageous for use in wood-coating formulations.

The composite particles obtainable by the various processes may have different structures. The composite particles may comprise one or more of the finely divided solid particles. The finely divided solid particles may be completely surrounded by the polymer matrix. However, it is also possible for a part of the finely divided solid particles to be surrounded by the polymer matrix while another part is arranged on the surface of the polymer matrix. It is of course also possible for a major part of the finely divided solid particles to be bound on the surface of the polymer matrix.

Usually, the composite particles obtainable by the various processes have a content of finely divided inorganic solid of ≧10% by weight, preferably ≧15% by weight and particularly preferably ≧20% by weight, ≧25% by weight or ≧30% by weight, based in each case on the composite particles (corresponding to the sum of amount of polymer and amount of solid particles). Those aqueous composite particle dispersions whose composite particles have a content of finely divided inorganic solid in the range of ≧10 and ≦50% by weight and particularly advantageously of ≧20 and ≦40% by weight are advantageously used according to the invention.

The abovementioned aqueous composite particle dispersions are advantageous as binders in wood-coating formulations.

Accordingly, wood-coating formulations according to the invention comprise an aqueous composite particle dispersion, in the preparation of the aqueous composite particle dispersion ethylenically unsaturated monomers being dispersed in an aqueous medium and polymerized by means of at least one free radical polymerization initiator in the presence of at least one dispersed, finely divided inorganic solid having a median particle diameter of ≦100 nm and at least one dispersant by the free radical aqueous emulsion polymerization method, and the ethylenically unsaturated monomers used being a monomer mixture which consists of ethylenically unsaturated monomers A and >0 and ≦10% by weight of at least one ethylenically unsaturated monomer B having an epoxide group (epoxide monomer).

For the purpose of this document, wood-coating formulations are understood as meaning all water-based formulations which are used for coating wood or wood surfaces, but in particular clear coats, wood glazes, wood paints or gloss varnishes. Clear coats are understood as meaning pigment-free, transparent-drying wood-coating formulations, wood glazes are understood as meaning transparent-drying coating formulations which have a low pigment content and enable the wood structure to be seen, wood paints are understood as meaning pigmented coating formulations which dry with good covering power and conceal the wood structure and gloss varnishes are understood as meaning pigmented coating formulations which dry with good covering power and have high gloss.

Depending on the planned use of the wood-coating formulations, they may comprise, in addition to the abovementioned aqueous composite particle dispersions, further customary formulation constituents, such as, for example, pigments and fillers, so-called film formation assistants, thickeners, antifoams, wetting agents and dispersants, neutralizing agents, anti-blue stain agents and/or preservatives, familiar to the person skilled in the art in type and amount.

Pigments which may be used are in principle all white or colored pigments familiar to the person skilled in the art.

Owing to its high refractive index and its good covering power, titanium dioxide in its various modifications may be mentioned as the most important white pigment. However, zinc oxide and zinc sulfide are also used as white pigments. These white pigments can be used in surface-coated or uncoated form. In addition, however, organic white pigments, such as, for example, non-film-forming hollow polymer particles rich in styrene and carboxyl groups and having a particle size from about 300 to 400 nm (so-called opaque particles) are also used.

In addition to white pigments, a very wide range of colored pigments familiar to the person skilled in the art, for example, the somewhat more economical inorganic iron, cadmium, chromium and lead oxides or sulfides, lead molybdate, cobalt blue or carbon black, and the somewhat more expensive organic pigments, for example, phthalocyanines, azo pigments, quinacridones, perylenes or carbozoles, can be used for coloring—for example of a coating material comprising the aqueous composite particle dispersion obtainable according to the invention.

Substantially inorganic materials having a lower refractive index compared with the pigments are used as fillers. The pulverulent fillers are frequently naturally occurring minerals, such as, for example, calcite, chalk, dolomite, kaolin, talc, mica, diatomaceous earth, barite, quartz or talc/chlorite intergrowths, but also synthetically prepared inorganic compounds, such as, for example, precipitated calcium carbonate, calcined kaolin or barium sulfate and pyrogenic silica. Calcium carbonate in the form of crystalline calcite or of amorphous chalk is preferably used as a filler.

Film formation assistants, also referred to as coalescence assistants, are used in order reliably to be able to form films at room temperature even from the polymers present in the composite particles and having a glass transition temperature of more than 20° C. These film formation assistants improve the film formation of the polymeric binders during the formation of the coating and are then released from the coating into the environment depending on the ambient temperature, the atmospheric humidity and the boiling point and the vapor pressure resulting therefrom. The film formation assistants which are known to the person skilled in the art are, for example, mineral spirit, water-miscible glycol ethers, such as butylglycol, butyldiglycol, dipropylene glycol monomethyl ether or dipropylene glycol butyl ether, and glycol acetates, such as butylglycol acetate or butyldiglycol acetate, but also esters of carboxylic acids and dicarboxylic acids, such as 2-ethylhexyl benzoate, 2,2,4-trimethylpentanediol 1,3-monoisobutyrate or tripropylene glycol monoisobutyrate.

In order to establish the optimum rheology of the wood-coating formulations during preparation, handling, storage and application, so-called thickeners or rheology additives are frequently used as a formulation constituent. A multiplicity of different thickeners is known to the person skilled in the art, for example organic thickeners, such as xanthan thickeners, guar thickeners (polysaccharides), carboxymethylcellulose, hydroxyethylcellulose, methylcellulose, hydroxypropylmethylcellulose, ethylhydroxyethylcellulose (cellulose derivates), alkali-swellable dispersions (acrylate thickeners) or hydrophobically modified polyether-based polyurethanes (polyurethane thickeners) or inorganic thickeners, such as bentonite, hectorite, smectite, attapulgite (bentones) and titanates or zirconates (metal organyls).

In order to avoid foam formation during preparation, handling, storage and application of the wood-coating formulations according to the invention, so-called antifoams are used. The antifoams are familiar to the person skilled in the art. They are substantially mineral oil antifoams and the silicone oil antifoams. Antifoams, especially the highly active silicone-containing ones, should generally be very carefully chosen and metered since they can lead to surface defects (craters, indentations, etc.) of the coating. What is important is that the antifoam effect can be further increased by addition of very finely divided, hydrophobic particles, for example hydrophobic silica or wax particles, to the antifoam liquid.

Wetting agents and dispersants are used in order to distribute pulverulent pigments and fillers optimally in the wood-coating formulations to be used according to the invention. The wetting agents and dispersants support the dispersing process by facilitating the wetting of the pulverulent pigments and fillers in the aqueous dispersion medium (wetting agent effect), by breaking up powder agglomerates (cleavage effect) and by steric or electrostatic stabilization of the primary pigment and filler particles forming in the shearing process (dispersant effect). Wetting agents and dispersants used are in particular those polyphosphates and salts of polycarboxylic acids which are familiar to the person skilled in the art, in particular sodium salts of polyacrylic acids or acrylic acid copolymers.

If required, inorganic or organic acids familiar to the person skilled in the art as neutralizing agents, such as, for example, hydrochloric, sulfuric, acetic or propionic acid, or bases, such as potassium hydroxide or sodium hydroxide solution, ammonia or ethylenediamine, can be used for adjusting the pH of the wood-coating formulations according to the invention.

Fungicides as so-called anti-blue stain agents can be mixed with the wood-coating formulations according to the invention for avoiding attack of the wood coating by blue stain fungi.

In order to avoid attack of the wood-coating formulations according to the invention during preparation, handling, storage and application by microorganisms, such as, for example, bacteria, molds, fungi or yeasts, preservatives or biocides familiar to the person skilled in the art are frequently used. In particular, active substance combinations comprising methyl- and chloroisothiazolinones, benzoisothiazolinones, formaldehyde or formaldehyde-donating agents are used.

In addition to the abovementioned formulation constituents, even further assistants familiar to the person skilled in the art, such as, for example, dulling agents, waxes or leveling agents, etc., can be added to the wood-coating formulations according to the invention during preparation, handling, storage and application.

The coating of moldings having at least one wood surface is effected as a rule by coating the wood surface with from 50 to 500 g/m², frequently from 100 to 400 g/m² and often from 200 to 350 g/m² of the wood-coating formulation (calculated as solid) and then drying said surface.

It is in principle unimportant whether the wood-coating formulation according to the invention is applied to the wood surface as a primer, i.e. directly to the untreated wood surface, as an outer coat, i.e. to the wood surface treated with a primer and/or as a so-called top coat, i.e. to the wood surface treated with an outer coat. In order to keep the water permeation and hence water absorption of the wood as low as possible, a wood-coating formulation according to the invention is advantageously applied as a primer, outer coat and top coat, particularly advantageously as an outer coat and as a top coat and especially advantageously exclusively as a top coat to the wood surface.

Typical primer formulations comprise as substantial formulation constituents:

from 10 to 25% by weight of composite particles according
to the invention
from 70 to 85% by weight of water
from 0.05 to 1% by weight of wetting agent
from 0.1 to 1% by weight of antifoam
from 0.1 to 3% by weight of anti-blue stain agent
from 0.1 to 2% by weight of associative thickener
from 0 to 4% by weight of transparent iron oxide pigment
from 0 to 5% by weight of film formation assistant
from 0.05 to 5% by weight of base

Typical outer coat formulations comprise as substantial formulation constituents:

from 20 to 40% by weight of composite particles according
to the invention
from 55 to 75% by weight of water
from 0.05 to 1% by weight of wetting agent
from 0.1 to 1% by weight of antifoam
from 0.1 to 3% by weight of anti-blue stain agent
from 0.1 to 2% by weight of associative thickener
from 0 to 4% by weight of transparent iron oxide pigment
from 0 to 5% by weight of film formation assistant
from 0.05 to 5% by weight of base

Typical top coat formulations comprise as substantial formulation constituents:

from 20 to 40% by weight of composite particles according
to the invention
from 55 to 75% by weight of water
from 0.05 to 1% by weight of wetting agent
from 0.1 to 1% by weight of antifoam
from 0.1 to 3% by weight of anti-blue stain agent
from 0.1 to 2% by weight of associative thickener
from 0 to 4% by weight of transparent iron oxide pigment
from 0 to 5% by weight of film formation assistant
from 0.05 to 5% by weight of base

For the coating of moldings having at least one wood surface, clear coats, wood glazes, wood paints or gloss varnishes which comprise composite particle dispersions according to the invention are frequently used.

Typical wood clear coats comprise as substantial formulation constituents:

from 20 to 40% by weight of composite particles according
to the invention
from 55 to 75% by weight of water
from 0.05 to 1% by weight of wetting agent
from 0.1 to 1% by weight of antifoam
from 0.1 to 3% by weight of anti-blue stain agent
from 0.1 to 2% by weight of associative thickener
from 0.1 to 5% by weight of UV absorber
from 0 to 5% by weight of film formation assistant
from 0.05 to 5% by weight of base

Typical wood glazes comprise as substantial formulation constituents:

from 20 to 40% by weight of composite particles according
to the invention
from 55 to 75% by weight of water
from 0.05 to 1% by weight of wetting agent
from 0.1 to 1% by weight of antifoam
from 0.1 to 3% by weight of anti-blue stain agent
from 0.1 to 2% by weight of associative thickener
from 0 to 4% by weight of transparent iron oxide pigment
from 0 to 5% by weight of film formation assistant
from 0.05 to 5% by weight of base

Typical wood paints comprise as substantial formulation constituents:

from 10 to 30% by weight of composite particles according
to the invention
from 25 to 65% by weight of water
from 0.05 to 1% by weight of wetting agent
from 0.1 to 1% by weight of antifoam
from 0.1 to 3% by weight of anti-blue stain agent
from 0.1 to 2% by weight of associative thickener
from 0.1 to 2% by weight of cellulose thickener
from 15 to 30% by weight of white pigment
from 5 to 15% by weight of filler
from 0 to 5% by weight of film formation assistant
from 0.05 to 5% by weight of base

Typical wood gloss varnishes comprise as substantial formulation constituents:

from 15 to 35% by weight of composite particles according
to the invention
from 50 to 75% by weight of water
from 0.05 to 1% by weight of wetting agent
from 0.1 to 1% by weight of antifoam
from 0.1 to 3% by weight of anti-blue stain agent
from 0.1 to 2% by weight of associative thickener
from 0.1 to 2% by weight of cellulose thickener
from 5 to 15% by weight of white pigment
from 0 to 5% by weight of film formation assistant
from 0.05 to 5% by weight of base

Particularly preferably, the aqueous composite particle dispersions according to the invention are used in water-based wood glazes.

The invention is explained in more detail with reference to the following, non-limiting examples.

### EXAMPLES

1. Preparation of the Aqueous Composite Particle Dispersions Dn

416.6 g of Nyacol® 2040 and thereafter a mixture of 2.5 g of methacrylic acid and 12 g of 10% strength by weight aqueous solution of sodium hydroxide are added within a period of 5 minutes at from 20 to 25° C. (room temperature) and atmospheric pressure under a nitrogen atmosphere and with stirring (200 revolutions per minute) to a 2 l four-necked flask equipped with a reflux condenser, a thermometer, a mechanical stirrer and metering apparatuses. Thereafter, a mixture of 10.4 g of a 20% strength by weight aqueous solution of the nonionic surfactant Lutensol® AT 18 (brand of BASF AG, C₁₆C₁₈-fatty alcohol ethoxylate having 18 ethylene oxide units) and 108.5 g of demineralized water was added to the stirred reaction mixture in the course of 15 minutes. Thereafter, 0.83 g of N-cetyl-N,N,N-trimethylammonium bromide (CTAB), dissolved in 200 g of demineralized water, was metered into the reaction mixture in the course of 60 minutes. The reaction mixture was then heated to a reaction temperature of 80° C.

At the same time, a monomer mixture consisting of X g of methyl methacrylate (MMA), Y g of n-butyl acrylate (n-BA), Z g of glycidyl methacrylate (GMA) and 0.5 g of methacryloyloxypropyltrimethoxysilane (MEMO) [the respective amounts are listed in table 1] was prepared as feed 1 and an initiator solution consisting of 2.5 g of sodium peroxodisulfate, 7 g of a 10% strength by weight aqueous solution of sodium hydroxide and 200 g of demineralized water was prepared as feed 2.

Thereafter, 21.1 g of feed 1 and 57.1 g of feed 2 were added in the course of 5 minutes via two separate feed pipes to the reaction mixture stirred at 80° C. The reaction mixture was then stirred for one hour at reaction temperature.

Thereafter, 0.92 g of a 45% strength by weight aqueous solution of Dowfax® 2A1 was added to the reaction mixture. In the course of 2 hours, beginning at the same time, the remaining amounts of feed 1 and feed 2 were metered continuously to the reaction mixture. The reaction mixture was then stirred for a further hour at reaction temperature and then cooled to room temperature.

The solids contents SC of the aqueous composition particle dispersions thus obtained were determined (also see table 1). The solids contents were determined by drying about 1 g of the respective aqueous composite particle dispersion in an open aluminum crucible having an internal diameter of about 3 cm in a drying oven at 150° C. to constant weight. For determining the solids contents, in each case two separate measurements were carried out. The values stated in table 1 correspond to the respective mean values of these two measurements.

The polymers of the composite particles obtained in the examples have a glass transition temperature of <5° C. (DIN 53 765).

The median particle diameter (d₅₀) of the composite particles obtained in examples D1 to D5 and DV, determined by means of the analytical ultracentrifuge method, is likewise stated in table 1.

TABLE 1
Amounts of monomers and properties of the resulting composite
particle dispersions DV and D1 to D5

| Dispersion | X [g] | | | | SC |
|---|---|---|---|---|---|
| Dn | n-BA | Y [g] MMA | Z [g] GMA | d₅₀ [nm] | [% by wt.] |
| DV | 130.0 | 117.5 | 0 | 67 | 35.3 |
| D1 | 128.8 | 116.2 | 2.5 | 65 | 34.8 |
| D2 | 127.5 | 115.0 | 5.0 | 67 | 35.1 |
| D3 | 126.2 | 113.8 | 7.5 | 63 | 35.3 |
| D4 | 124.9 | 112.6 | 10.0 | 65 | 34.9 |
| D5 | 123.6 | 111.4 | 12.5 | 68 | 35.2 |

2. Preparation of Wood Glazes Using the Composite Particle Dispersions DV and D1 to D5 and the Performance Characteristics Thereof

The corresponding protective wood glazes HD1 to HD5 and HDV were formulated from the aqueous composite particle dispersions D1 to D5 and DV by mixing the following components in the stated sequence at room temperature:

20.25 g of water
2.50 g of Mergal ® S 96 (fungicide and algicide from Troy Chemie
GmbH, Seelze.)
0.25 g of Byk ® 346 (wetting agent from Byk Chemie GmbH, Wesel)
0.50 g of Byk ® 024 (antifoam from Byk Chemie GmbH, Wesel)
0.25 g of AMP ® 90 (dispersant, Angus Chemical Company, Buffalo
Grove, USA)
1.25 g of Rheoloate ® 278 (thickener, Elementis Specialties Inc.,
Highstown, USA)
7.50 g of Luconyl ® yellow (pigment preparation from BASF AG)
70.20 g of composite particles in the form of their aqueous dispersions
DV or D1 to D5
17.50 g of water

For testing the water permeability of the wood glazes prepared, spruce boards having a thickness of 2 cm, a width of 10 cm and a length of 30 cm were coated on a surface (10×30 cm) as follows with the abovementioned wood glazes:
a) priming with the respective wood glaze HD1 to HD5 and HDV, which had been diluted with demineralized water in the weight ratio 1:1; coating weight 40 g/m² (wet); drying for 24 hours at 23° C. and 50% relative humidity; then sanding of the primed wood surface with a commercial abrasive paper of grain size P 220; then
b) application of the outer coat in the form of the respective wood glaze HD1 to HD5 and HDV to the primed wood surface; coating weight 80 g/m² (wet); drying for 24 hours at 23° C. and 50% relative humidity; then sanding of the wood surface coated with the outer coat with a commercial abrasive paper of grain size P 220; then
c) application of the top coat in the form of the respective wood glaze HD1 to HD5 and HDV to the wood surface coated with the outer coat; coating weight 80 g/m² (wet); drying for 24 hours at 23° C. and 50% relative humidity.

The primer, outer coat and top coat were each based on one of the wood glazes HD1 to HD5 and HDV (i.e. a wood glaze was used for the primer, outer coat and top coat). The coated wood bodies were then dried for 3 days at 50° C. in a drying oven and then stored for 24 hours at room temperature. The coated spruce boards were now weighed and then placed with the coated side on 10×8×8 cm sponges for flower arranging (from the florists' trade), which had been stored in a water reservoir and were completely impregnated with water. In each case double determinations based on DIN EN 927-5 were carried out. The coated wood bodies were weighed after 24, 48 and 72 hours and the water absorption in grams per square meter was determined from the weight increase. The values stated in table 2 are the mean values of the double determinations.

TABLE 2
Water absorption [in g/m²] of the coated wood bodies as a
function of time [in hours]

wood glaze

| Time | HDV | HD1 | HD2 | HD3 | HD4 | HD5 |
|---|---|---|---|---|---|---|
| 24 | 754 | 566 | 463 | 438 | 434 | 435 |
| 48 | 1049 | 776 | 660 | 640 | 631 | 601 |
| 72 | 1186 | 926 | 796 | 770 | 668 | 665 |

The abovementioned table clearly shows that the wood bodies coated with the wood glazes HD1 to HD5 according to the invention exhibit substantially less water absorption than the wood bodies coated with the comparative glaze HDV. The abovementioned reduction in the water absorption (due to the reduced water permeability of the wood coating) is also reflected in improved stability of the coated wood bodies to outdoor weathering, in particular due to substantially less growth of blue stain fungus.

1. A binder in wood-coating formulations, comprising an aqueous composite particle dispersion identified as an aqueous dispersion of particles composed of polymer and finely divided inorganic solid prepared by dispersing ethylenically unsaturated monomers in an aqueous medium and polymerizing them by the free radical aqueous polymerization method using at least one free radical polymerization initiator in the presence of at least one dispersed, finely divided inorganic solid having a median particle diameter of ≦100 nm and at least one dispersant, wherein the ethylenically unsaturated monomers of the polymer portion of said dispersion comprise a monomer mixture consisting of ethylenically unsaturated monomers A and >0 and ≦10% by weight of at least one ethylenically unsaturated monomer B having an epoxide group.

2. The binder according to claim 1, wherein the finely divided inorganic solid is selected from the group consisting of silica, alumina, hydroxyaluminum oxide, calcium carbonate, magnesium carbonate, calcium orthophosphate, magnesium orthophosphate, iron(II) oxide, iron(III) oxide, iron(II/III) oxide, tin(IV) oxide, cerium(IV) oxide, yttrium(III) oxide, titanium dioxide, hydroxylapatite, zinc oxide and zinc sulfide.

3. The binder according to claim 1, wherein the finely divided inorganic solid is pyrogenic and/or colloidal silica, a silica sol and/or a sheet silicate.

4. The binder according to claim 1, wherein the monomer having an epoxide group is glycidyl acrylate and/or glycidyl methacrylate.

5. The binder according to claim 1, wherein the monomer mixture comprises from 0.01 to 5% by weight, based on the total amount of the monomers A, of ethylenically unsaturated monomers which have a siloxane group.

6. The binder according to claim 1, wherein the total amount of the at least one epoxide monomer in the monomer mixture is from 0.1 to 5% by weight.

7. The binder according to claim 1, wherein the composition of the monomers A is chosen so that, after polymerization of them alone, a polymer is produced whose glass transition temperature is ≦60° C.

8. A wood-coating formulation comprising an aqueous composite particle dispersion identified as an aqueous dispersion of particles composed of polymer and finely divided inorganic solid prepared by dispersing ethylenically unsaturated monomers in an aqueous medium and polymerizing them by the free radical aqueous polymerization method using at least one free radical polymerization initiator in the presence of at least one dispersed, finely divided inorganic solid having a median particle diameter of ≦100 nm and at least one dispersant, wherein the ethylenically unsaturated monomers of the polymer portion of said dispersion comprise a monomer mixture consisting of ethylenically unsaturated monomers A and >0 and ≦10% by weight of at least one ethylenically unsaturated monomer B having an epoxide group.

9. A method for coating moldings having at least one wood surface, wherein the wood surface is coated with from 50 to 500 g/m² of the wood-coating formulation according to claim 8, calculated as solid, and then dried.

10. A molding obtained by the method according to claim 9.
